(19) United States
(12) Patent Application Publication
(10) Pub. No.: US 2010/0101388 A1
(43) Pub. Date: Apr. 29, 2010

(54) QUICK-RELEASE MECHANISM FOR SAW MACHINE

(75) Inventor: Jung-Huo CHEN, Taichung (TW)

Correspondence Address: BACON & THOMAS, PLLC, 625 SLATERS LANE, FOURTH FLOOR, ALEXANDRIA, VA, 22314-1176, US

(73) Assignee: Rexon Industrial Corp., Ltd., Taichung (TW)

(21) Appl. No.: 12/603,791

(22) Filed: Oct. 22, 2009

(30) Foreign Application Priority Data
Oct. 27, 2008 (TW) 097141177

(51) Int. Cl. B27G 19/08

(52) U.S. Cl. 83/102.1; 83/701

(57) ABSTRACT

A quick-release mechanism for use in a saw machine includes a mounting member, which has a top side and a retaining slot adjacent to the top side, a connection member, which has an opening for attaching to the top side of the mounting member, and a locking member, which has a pivot portion pivotally connected to the connection member. A lever extends from the pivot portion and is operable to move the pivot portion relative to the connection member. An engagement portion joined to the pivot portion is movable with the pivot portion into or out of the retaining slot to lock the connection member to the mounting member or to unlock the connection member from the mounting member.

### FIELD OF THE INVENTION

The present invention relates to wood processing machinery and more particularly, to a quick-release mechanism for use in a saw machine.

### BACKGROUND

A saw machine generally has many safety devices to ensure operation safety. For example, a riving knife fixedly provided at the machine table behind the saw blade separates two cut pieces of wood, so as to eliminate kickback. Two check pawls may be respectively pivotally provided at two sides of the riving knife and configured to engage the workpiece to prohibit kickback of the cut pieces. A guard may be pivotally provided at the top side of the riving knife and extending over the top side of the saw blade to shield the top side of the saw blade.

In order to meet international safety codes, the installation and maintenance of the component parts of a saw machine are relatively complicated. To facilitate installation and maintenance, saw machine safety devices are commonly made detachable. In consequence, different quick-release mechanisms are extensively used with safety devices in saw machines.

According to the quick-release mechanisms of certain commercial saw machines, such as those described in TW M328333, TW I269680 (equivalent to U.S. Pat. No. 7,302,878), TW 200823029 (equivalent to U.S. publication no. 2008/0121080) and TW M288213 (equivalent to U.S. Pat. No. 7,210,386), a lock pin is commonly used for single-point locking control. Further, according to the design shown in FIG. 1 (TW M288213), the quick-release mechanism comprises a locating hole 101 formed in a notch located on the top side of the riving knife 1. The notch has an open end and a closed end and an inner diameter of the closed end is greater than the size of the opening at the open end. A connection member 2 is located on the riving knife 1 for the pivotal connection of check pawls or a guard thereto. A pin 201 inserted through the connection member 2 has a neck 203, and a spring member 202 arranged concentrically on the pin 201 to impart a pressure to the pin 201 so as to hold the pin 201 in such a position where the neck 203 is maintained spaced from the locating hole 101 such that the pin 201 is retained in the locating hole 101, and the connection member 2 is maintained in position on the riving knife 1. This configuration of the single-point locking design of a quick-release mechanism is less stable. Further, the whole structure of the quick-release mechanism is complicated.

There are other known designs that eliminate the use of a spring means. For example, U.S. publication no. 2008/0022826 shows a spring free design, however the design is of a single-point locking type. Further, U.S. publication no. 2008/0047409 discloses a double-point locking design. According to this design, as shown in FIG. 2, the quick-release mechanism comprises two L-shaped locating holes 301 located on the top side of a riving knife 3. A connection member 4 is pivotally connected to a guard (not shown), and two blocks 5 are fixedly provided at the bottom side of the connection member 4 for attaching to the top side of the riving knife 3. Two pins 501 are respectively mounted in the blocks 5 for being received in the L-shaped locating holes 301. A knob 6 is mounted on the connection member 4 and is rotatable to tighten the connection member 4 to the riving knife 3. According to this design, a large amount of time is required to install and uninstall the quick-release mechanism.

### SUMMARY

The present disclosure has been accomplished under the circumstances in view. Thus, embodiments of the present disclosure provide a quick-release mechanism for a saw machine, which allows quick mounting and dismounting, and assures a high level of locking safety.

To achieve this and other objects, a quick-release mechanism for use in a saw machine comprises a mounting member, a connection member selectively attachable to the mounting member, and a locking member for locking the connection member to the mounting member. The mounting member has a first lateral side, a second lateral side opposite to the first lateral side, a top side joining the first lateral side and the second lateral side at one side, and a retaining slot formed in the first lateral side adjacent to the top side. The connection member has a bearing surface for bearing against the top side of the mounting member and a positioning surface joined to the bearing surface for positioning on the first lateral side of the mounting member. The locking member has a pivot portion facing the first lateral side of the mounting member and pivotally coupled to the connection member. A lever extends from the pivot portion to the outside of the connection member and is operable to move the pivot portion relative to the connection member. An engagement portion disposed at one side of the pivot portion is movable with the pivot portion relative to the connection portion between a first position, where the engagement portion is maintained spaced from the retaining slot of the mounting member for allowing removal of the connection member from the mounting member, and a second position where the engagement portion is engaged with the retaining slot to lock the connection member to the mounting member.

By means of manipulating the lever of the locking member to move the engagement portion into or out of the retaining slot, the connection member is locked or unlocked from the mounting member. Thus, this quick-release mechanism has a simple structure and is easy to operate.

### BRIEF DESCRIPTION OF THE DRAWINGS

Other advantages and features of the present invention will be understood by reference to the following specification in conjunction with the accompanying drawings, in which like reference characters denote like elements of structure.

FIG. 1 is a schematic installed view of a quick-release mechanism according to the prior art.

FIG. 2 is a schematic installed view of another structure of a quick-release mechanism according to the prior art.

FIG. 3 is an exploded view of a quick-release mechanism in accordance with a first embodiment of the present disclosure.

FIG. 4 is an elevational assembly view of the quick-release mechanism in accordance with the first embodiment of the present disclosure.

FIG. 5 is a schematic front view of the first embodiment of the present disclosure, showing the connection member of the quick-release mechanism attached to the mounting member.

FIG. 6 is a sectional view taken along line VI-VI of FIG. 5.

FIG. 7 is a view similar to FIG. 6, showing the lever of the locking member moved from the first position to the second position and the engagement portion of the locking member moved into the retaining slot of the mounting member.

FIG. 8 is a schematic drawing showing the quick-release mechanism of the first embodiment of the present disclosure used with a guard.

FIG. 9 is an exploded view of a quick-release mechanism in accordance with a second embodiment of the present disclosure.

FIG. 10 is a schematic drawing of the second embodiment of the present disclosure, showing the connection member attached to the mounting member.

FIG. 11 is a view similar to FIG. 10, but showing the lever of the locking member moved from the first position to the second position and the engagement portion of the locking member engaged with the retaining slot of the mounting member and the locating hole of the connection member.

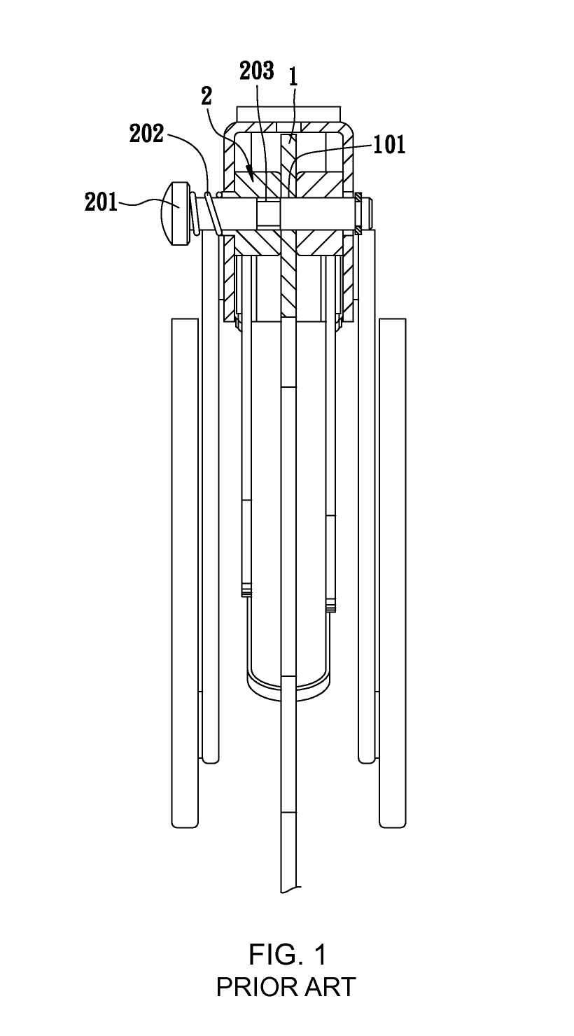

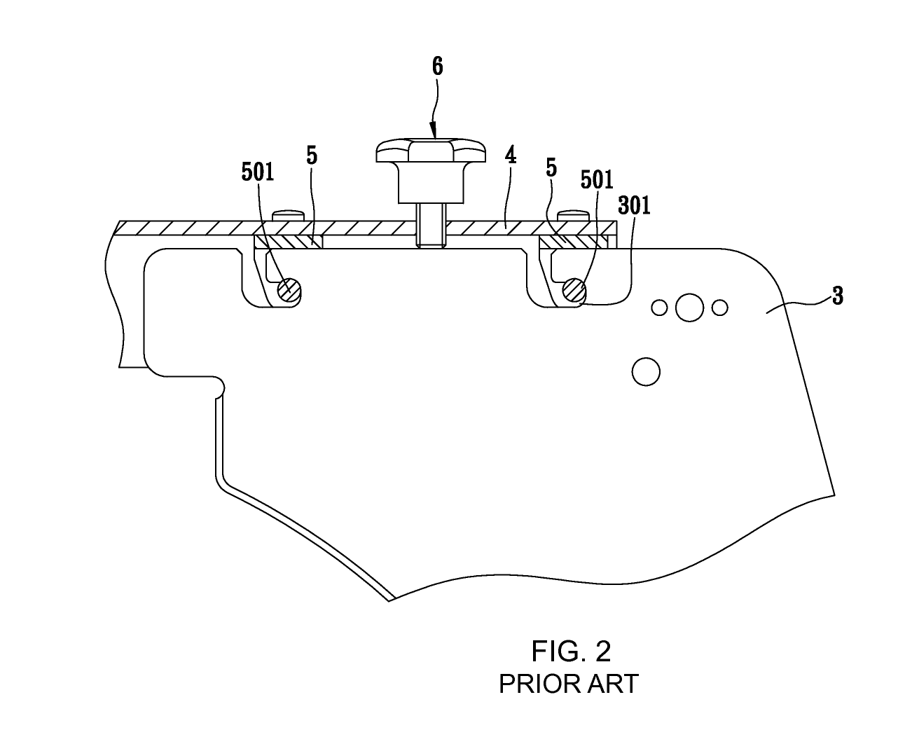

### DETAILED DESCRIPTION

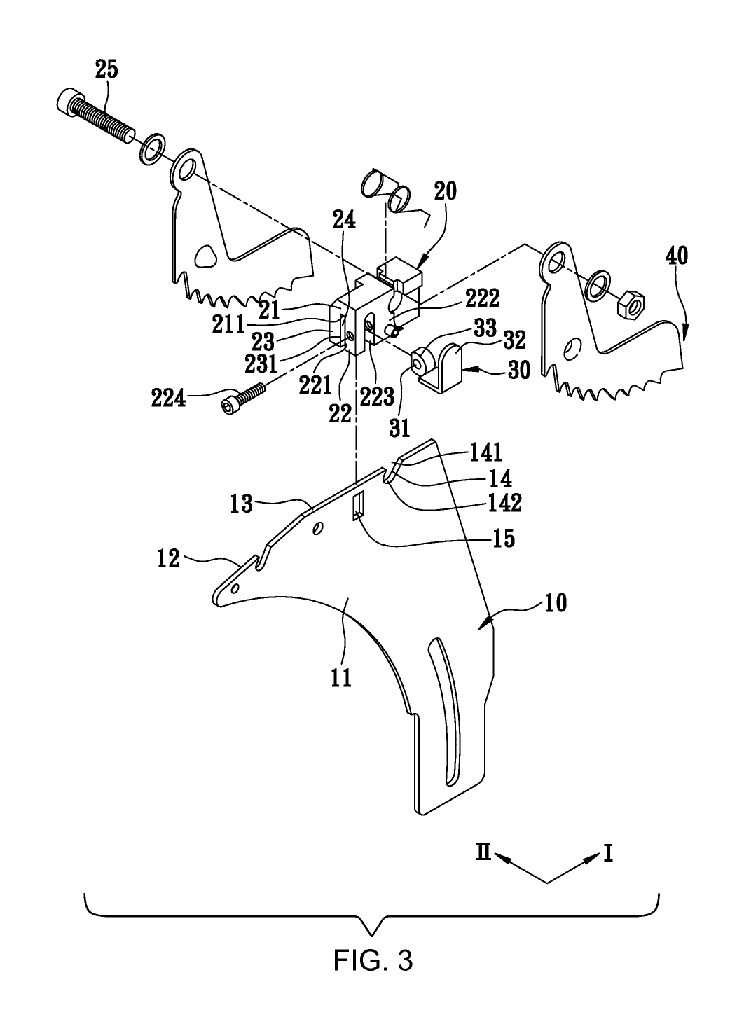

Referring to FIG. 3, a quick-release mechanism for use in a saw machine in accordance with a first embodiment of the present disclosure is shown comprising a mounting member 10, a connection member 20, and a locking member 30 for locking the connection member 20 to the mounting member 10. According to this embodiment, the mounting member 10 is a riving knife. The connection member 20 is adapted for the pivotal connection of two check pawls 40 at two sides relative to the mounting member 10.

The mounting member 10 is a flat plate member having a first lateral side 11, and a second lateral side 12 opposite to the first lateral side 11. A top side 13 joins the topmost edge of the first lateral side 11 and the topmost edge of the second lateral side 12 and extends in a first direction I. A locating notch 14 is positioned on the top side 13, and a retaining slot 15 extends through the first lateral side 11 and the second lateral side 12 adjacent to the locating notch 14. The locating notch 14 and the retaining slot 15 extend through the first lateral side 11 and the second lateral side 12 in a second direction II perpendicular to the first direction I. The locating notch 14 has an open end 141 corresponding to the top side 13, and a closed end 142 obliquely extended from the open end 141 toward the retaining slot 15.

The connection member 20 has an inverted U-shaped cross section and is selectively attachable to the mounting member 10 The connection member 20 has a top wall 21 corresponding to the top side 13 of the mounting member 10, a first sidewall 22 perpendicularly extending from the top wall 21 at one lateral side corresponding to the first lateral side 11 of the mounting member 10, and a second sidewall 23 perpendicularly extended from the top wall 21 at the other lateral side corresponding to the second lateral side 12 of the mounting member 10 and disposed in a parallel manner relative to the first sidewall 22. An opening 24 is surrounded by the top wall 21 and the first and second sidewalls 22 and 23, and a cross rod 25 is inserted through the first sidewall 22 and the second sidewall 23 across the opening 24 in the second direction II. The top wall 21 has a bearing surface 211 for bearing against the top side 13 of the mounting member 10. The first sidewall 22 has an inner surface, namely, the first positioning surface 221, joined to the bearing surface 211 for positioning on the first lateral side 11 of the mounting member 10. An outer surface 222 is formed opposite to the first positioning surface 221, a coupling hole 223 extends through the outer surface 222 to the first positioning surface 221, and a shaft pin 224 is fastened to the first sidewall 22 in the first direction I and extends across the coupling hole 223. The second sidewall 23 has an inner surface, namely, the second positioning surface 231, opposing the first positioning surface 221. The cross rod 25 has two opposite ends respectively extending past the first sidewall 22 and the second sidewall 23 for the mounting of the check pawls 40.

The locking member 30 has a pivot portion 31 facing the first lateral side 11 of the mounting member 10 and pivotally coupled to the shaft pin 224. A lever 32 extends from the pivot portion 31 to the outside of the connection member 20, and a engagement portion 33 is disposed at one side of the pivot portion 31 and is movable with the locking member 30 within the coupling hole 223. The engagement portion 33 is shaped like a cam.

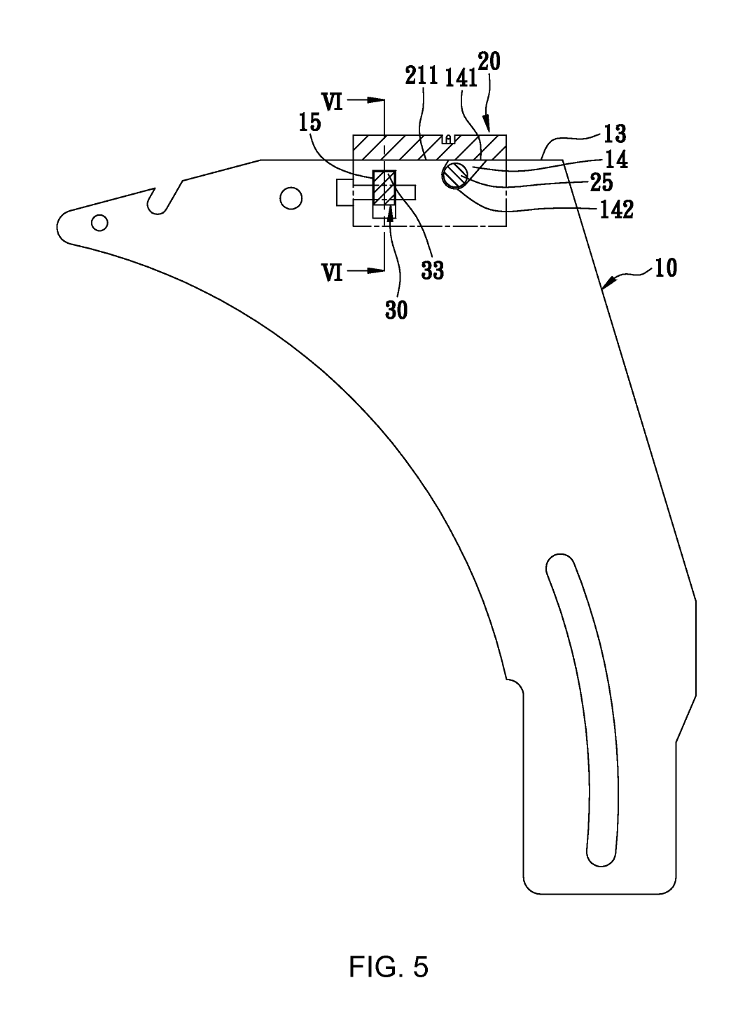

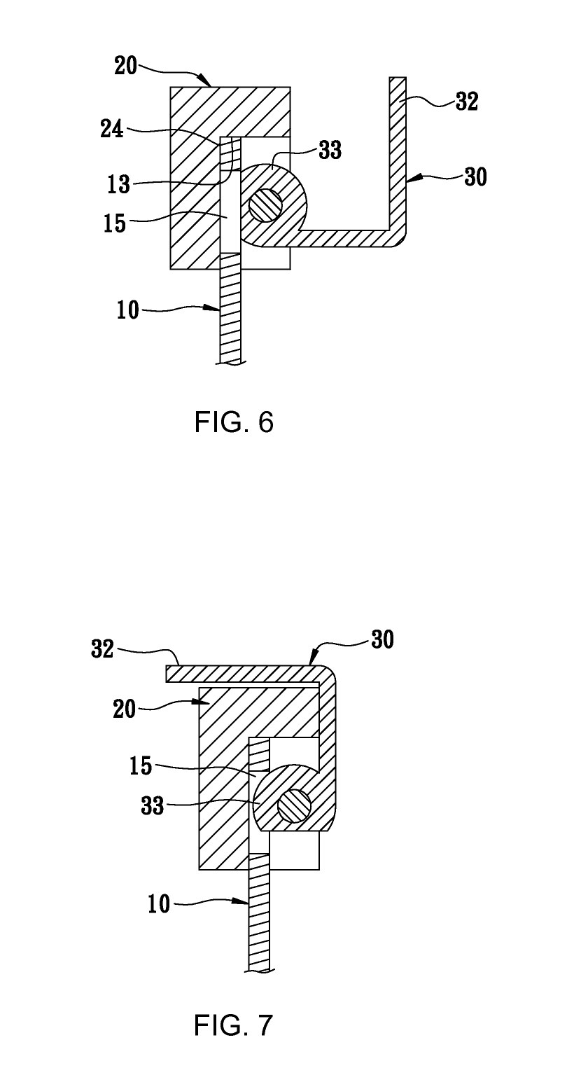

Referring to FIGS. 5 and 6, to connect the connection member 20 to the mounting member 10, the locking member 30 is manipulated to move the engagement portion 33 out of the opening 24 to a first position (unlocking position). Then the opening 24 of the connection member 20 is positioned on the top side 13 of the mounting member 10 to insert the cross rod 25 into the locating notch 14 and to move the cross rod 25 from the open end 141 to the closed end 142. At this time, the bearing surface 211 bears against the top side 13 of the mounting member 10 and the engagement portion 33 of the locking member 30 is in accurate alignment with the retaining slot 15.

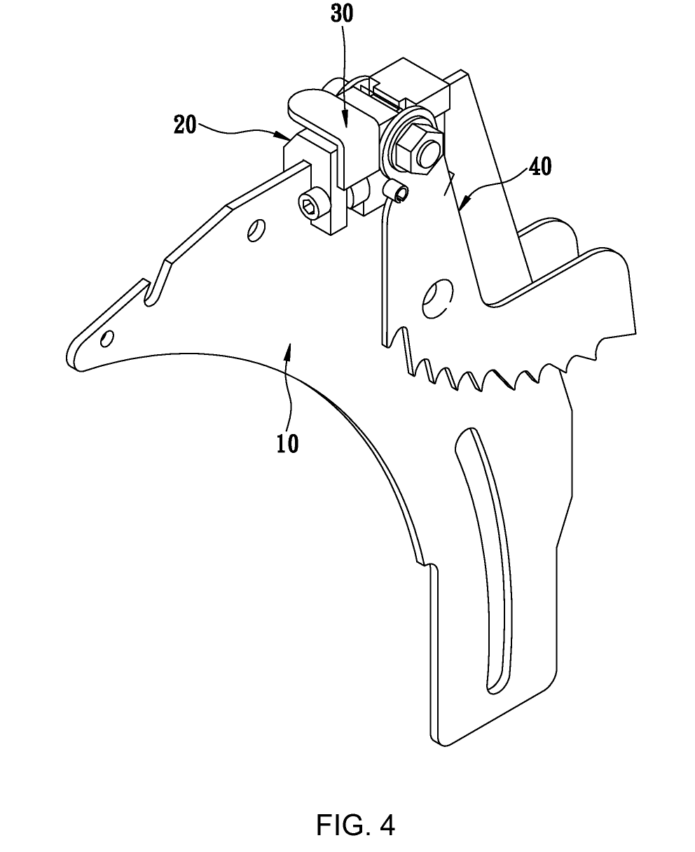

Thereafter, the lever 32 is moved from the first position (unlocking position) where the engagement portion 33 is maintained outside the retaining slot 15 (see FIG. 6) to a second position (locking position) where the engagement portion 33 is moved into the retaining slot 15 (see FIG. 7), thereby locking the connection member 20 to the mounting member 10 and maintaining the check pawls 40 in position relative to the mounting member 10 for protection (see FIG. 4).

To dismount the quick-release mechanism, the lever 32 is moved from the second position (locking position) shown in FIG. 7 to the first position (unlocking position) shown in FIG. 6 to move the engagement portion 33 away from the retaining slot 15. Thus, the operation of the quick-release mechanism is quite simple.

Thus, the quick-release mechanism of the present disclosure has a simple structure and is easy to fabricate. Mounting and dismounting operations of the quick-release mechanism are simple. By means of inserting the cross rod 25 into the locating notch 14 and engaging the engagement portion 33 with the retaining slot 15, the connection member 20 is locked to the mounting member 10 in a two-point locking manner, assuring a high level of locking safety. Further, there is no additional operating procedure necessary to move the cross rod 25 into or out of the locating notch 14. Attaching the connection member 20 to the mounting member 10 or removing the connection member 20 from the mounting member simultaneously moves the cross rod 25 into or out of the locating notch 14.

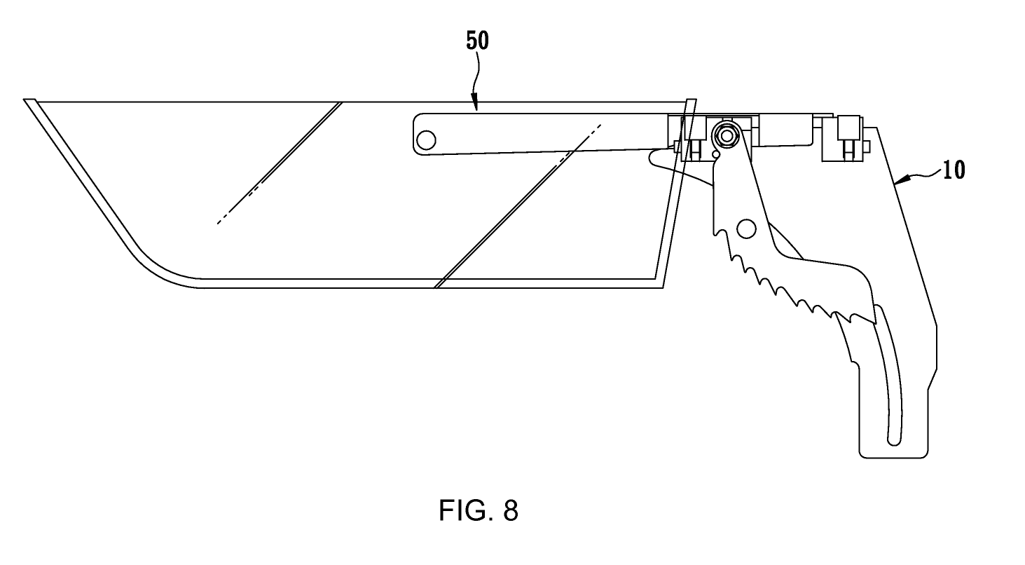

Referring to FIG. 8, the quick-release mechanism in accordance with the first embodiment of the present disclosure can also be used for locking a guard 50 to a mounting member (riving knife) 10.

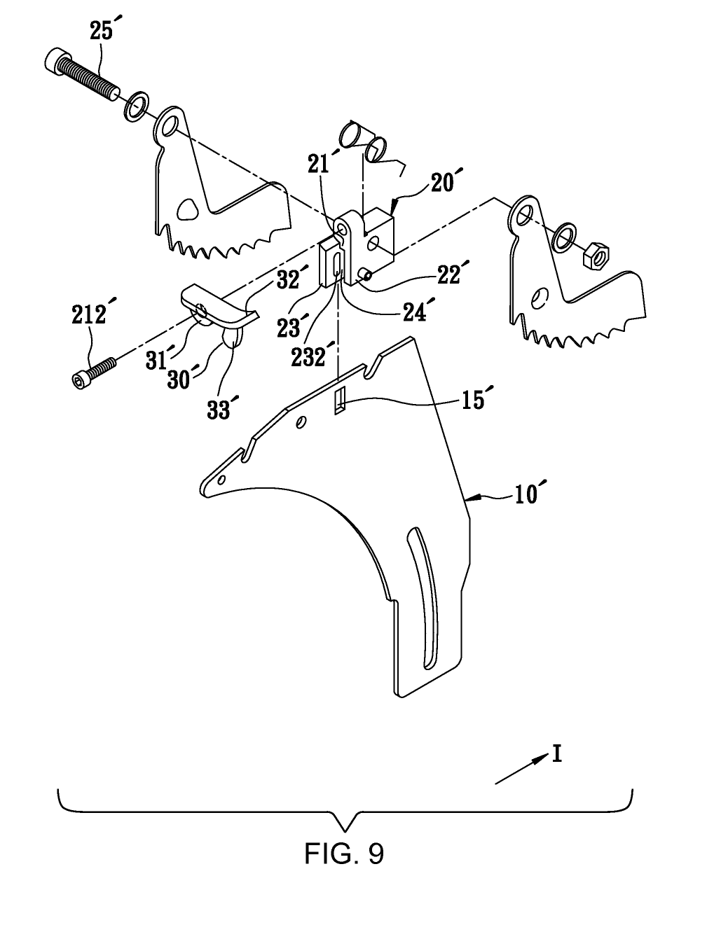

Referring to FIG. 9, a quick-release mechanism in accordance with a second embodiment of the present disclosure is shown comprising a mounting member 10′, a connection member 20′, and a locking member 30′. The mounting member 10′ is the same as the mounting member 10 of the aforesaid first embodiment. The connection member 20′ is an inverted U-shaped member having a top wall 21′, a first sidewall 22′, a second sidewall 23′, an opening 24′ and a cross rod 25′. The top wall 21′ has a shaft pin 212′ fastened thereto in the first direction I. The second sidewall 23′ has a locating hole 232′ corresponding to a retaining slot 15′ on the mounting member 10′. The locking member 30′ has a pivot portion 31′ pivotally coupled to the shaft pin 212′, a lever 32′ fixedly connected to one side of the pivot portion 31′, and an engagement portion 33′ shaped like an arcuate hook and fixedly connected to the pivot portion 31′ and one side of the lever 32′.

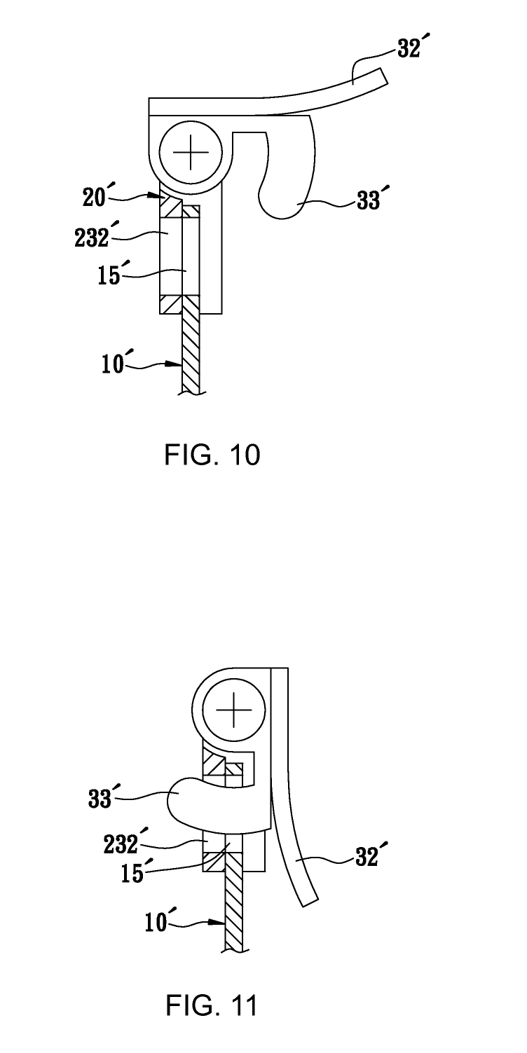

As shown in FIGS. 10 and 11, the lever 32′ can be moved from the first position (unlocking position) where the engagement portion 33′ is maintained outside the retaining slot 15′ and the locating hole 232′ (see FIG. 10) to a second position (locking position) where the engagement portion 33′ is inserted into the retaining slot 15 and the locating hole 232′ (see FIG. 11), thereby locking the connection member 20′ to the mounting member 10′. This second embodiment achieves the same effects as the aforesaid first embodiment.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A quick-release mechanism for use in a saw machine, comprising:
a mounting member having a first lateral side, a second lateral side opposite to said first lateral side, a top side joining said first lateral side and said second lateral side at one side, and a retaining slot formed in said first lateral side adjacent to said top side;
a connection member selectively attachable to said mounting member, said connection member having a bearing surface arranged to bear against said top side of said mounting member, and a positioning surface joined to said bearing surface an positionable on said first lateral side of said mounting member; and
a locking member locking said connection member to said mounting member, said locking member having a pivot portion facing said first lateral side of said mounting member and pivotally coupled to said connection member, a lever extends from said pivot portion to the outside of said connection member and moves said pivot portion relative to said connection member, and an engagement portion disposed at one side of said pivot portion and movable with said pivot portion relative to said connection portion between a first position, whereat said engagement portion is maintained spaced from said retaining slot of said mounting member for removal of said connection member from said mounting member, and a second position, whereat said engagement portion engages said retaining slot and locks said connection member to said mounting member.

2. The quick-release mechanism as claimed in claim 1, wherein said connection member is an inverted U-shaped member, having a top wall carrying said bearing surface, a first sidewall and a second side wall perpendicularly extend from said top wall in a parallel manner, an opening defined between said first sidewall and said second sidewall for receiving said mounting member, and said second sidewall carrying said positioning surface; and said pivot portion of said locking member is pivotally connected to said first sidewall of said connection member.

3. The quick-release mechanism as claimed in claim 2, wherein said engagement portion of said locking member is a cam.

4. The quick-release mechanism as claimed in claim 2, wherein said mounting member has a locating notch positioned on said top side adjacent to said retaining slot; said connection member has a cross rod fixedly fastened to said first and second sidewalls and extending across said opening for selective engagement with said locating notch of said mounting member.

5. The quick-release mechanism as claimed in claim 4, wherein said locating notch of said mounting member has an open end corresponding to said top side and a closed end obliquely extended from said open end toward said retaining slot.

6. The quick-release mechanism as claimed in claim 1, wherein said connection member is an inverted U-shaped member having a top wall carrying said bearing surface, a first sidewall and a second sidewall perpendicularly extend from said top wall in a parallel member, an opening defined between said first sidewall and said second sidewall for receiving said mounting member, and said second sidewall carrying said positioning surface; and said pivot portion of said locking member is pivotally connected to said top wall of said connection member.

7. The quick-release mechanism as claimed in claim 6, wherein said engagement portion of said locking member has the shape of an arcuate hook.

8. The quick-release mechanism as claimed in claim 6, wherein said mounting member has a locating notch positioned on said top side adjacent to said retaining slot; said connection member has a cross rod fixedly fastened to said first and second sidewalls and extending across said opening for selective engagement with said locating notch of said mounting member.

9. The quick-release mechanism as claimed in claim 8, wherein said retaining slot of said mounting member extends through said first and second lateral sides adjacent to said top side; said second sidewall of said connection member has a locating hole corresponding to said retaining slot; and said engagement portion of said locking member is inserted through said retaining slot into said locating hole when said locking member is moved from said first position to said second position.

10. The quick-release mechanism as claimed in claim 8, wherein said locating notch of said mounting member has an open end corresponding to said top side and a closed end obliquely extended from said open end toward said retaining slot.

11. The quick-release mechanism as claimed in claim 1, wherein said mounting member is a riving knife.
